(19) United States
(12) Patent Application Publication
(10) Pub. No.: US 2007/0263402 A1
(43) Pub. Date: Nov. 15, 2007

(54) HEADLAMP OPTICAL MODULE FOR A MOTOR VEHICLE

(75) Inventor: Antoine de Lamberterie, Paris (FR)

Correspondence Address: MATTHEW R. JENKINS, ESQ., 2310 FAR HILLS BUILDING, DAYTON, OH, 45419, US

(73) Assignee: VALEO VISION, BOBIGNY Cedex (FR)

(21) Appl. No.: 11/746,770

(22) Filed: May 10, 2007

(30) Foreign Application Priority Data
May 12, 2006 (FR) 0604386

(51) Int. Cl. F21V 1/00

(52) U.S. Cl. 362/509

(57) ABSTRACT

Headlamp optical module for a motor vehicle comprising, disposed along an optical axis: an elliptical-type reflector with at least one light source placed in the vicinity of a first focal point of the reflector; a converging lens placed in front of the reflector and admitting a focal point located in the vicinity of the second focal point of the reflector; and a light recovery means suitable for collecting a portion of the flux from the source and for sending it forward. An ellipsoid-type reflector is provided at the front, in the upper portion of the module, this reflector focusing a portion of the rays issuing from the source in the vicinity of a second focal point located at the front, lower than the focal point of the lens, and the light recovery means has an input face, in proximity to which is located the second focal point of the ellipsoid-type reflector.

### 1. BACKGROUND OF THE INVENTION

I. Field of Invention

The invention relates to a headlamp optical module for a motor vehicle of the type of those which comprise, disposed along an optical axis:

an elliptical-type reflector with at least one light source placed in the vicinity of a first focal point of the reflector;

a converging lens placed in front of the reflector and admitting a focal point located in the vicinity of the second focal point of the reflector, or combined therewith.

II. Description of the Related Art

A headlamp can be composed of one or more, similar or differing optical modules.

In a light headlamp module of this type, a portion of the light flux emitted by the source is lost. Efforts have therefore been made to improve the performance levels of elliptical-type optical systems, in particular with a xenon or halogen source, with a significant light contribution in zones of the beam requiring this contribution.

JP 2003 338210 proposes to improve the performance levels of the elliptical technology using a light recovery means capable of collecting a portion of the light flux directed downward and originating from the source and of sending it toward the front of the vehicle.

However, the part made of transparent material, glass or plastics material forming the light recovery means according to JP 2003 338210 is of a large size which is incompatible with industrial molding conditions and makes this part difficult to implant in a light headlamp. The inlet of the part is of fresnelised shape in order to collimate the rays, and this inlet is of considerable size. Accordingly, it becomes difficult to modify the beam, for example, for an AFS application, by masking this zone as a large surface area has to be concealed.

The collimation of the rays and the guarantee of obtaining a cut-off in the beam require optimum adjustment of the position of the part relative to the source, rendering the mechanical production of the system complex.

There is, therefore, a need to provide an improved optical module that overcomes one or more problems in the prior art.

### SUMMARY OF THE INVENTION

The object of the invention is, above all, to provide an elliptical-type headlamp module in which the recovery of light is improved and efficiency increased in a simple manner in terms of implementation.

According to the invention, an optical headlamp module for a vehicle of the type defined hereinbefore which comprises, in its low portion, a light recovery means suitable for collecting a portion of the flux from the source (in particular heading toward the rear) and for sending it forward, is such that:

an ellipsoid-type reflector (6) is provided at the front, in the upper portion of the module, this reflector (6) focusing a portion of the rays issuing from the source (E) in the vicinity of a second focal point (μ₂) located at the front, lower than the focal point (FL) of the lens (L),

and the light recovery means has an edge in proximity to the second focal point of the elliptical mirror forming the cut-off edge.

The term “an ‘ellipsoid-type’ headlamp” refers to a reflector which is substantially ellipsoidal in shape or the behaviour of which is related/comparable to that of an ellipsoid reflector. The same applies to the “elliptical-type” reflector. “High” or “low” are terms to be understood for the module in the configuration which it has in the headlamp in the position in which it is fitted in the vehicle.

Advantageously, the upper front portion of the elliptical reflector is stopped in the region of a zone corresponding to the end rays which, after reflection onto the reflector, are collected as limit rays by the lens.

Preferably, the recovery means is made of a one-piece transparent material. The recovery means comprises an input face inclined on the optical axis of the headlamp, having an upper limit forming the cut-off edge. The input face of the recovery means is disposed so that the rays reflected by the ellipsoid-type reflector and falling onto this input face are hardly deflected. This input face is preferably substantially planar.

The recovery means can be limited in its low portion by an inclined surface, in particular an inclined plane, operating in total reflection, the rays being straightened by the recovery means in order especially—on average—to be substantially parallel to the optical axis of the output face of the recovery means.

Advantageously, the output face of the recovery means is generated by revolution about the optical axis. The output face can admit as the meridian vertical section an elliptic arc, one focal point of which is the image, provided by the inclined plane, of the second focal point of the ellipsoid-type reflector, in order to form an emerging beam admitting a planar wave surface, substantially orthogonal to the optical axis.

According to a further possibility, the output face admits as the horizontal section that of a given quadric to provide at the output a cylindrical wave plane having substantially vertical generatrices.

The light headlamp module can comprise a movable shield in the region of the input face of the recovery means, this shield being able to be placed in a withdrawn position, in which it allows the light to pass toward the input face, or to occupy a position in which it blocks out this light.

This module can be mounted so as to be movable and the recovery means can be fixed and placed in such a way that in the rest position of the headlamp the light originating from the additional ellipsoid-type reflector passes beside the recovery means, whereas in the operating position the headlamp is positioned facing the recovery means which then becomes active.

The light headlamp module can comprise a shield located between the reflector and the lens, limited by an end edge, forming a cut-off edge, located in the vicinity of the focal point of the lens.

The recovery means can comprise an input face which is inclined on the optical axis and the upper limit of which is formed by an edge passing through the focal point of the system formed by a planar mirror and the dioptre of the output face.

The recovered beam can be a beam without a cut-off, the recovery means comprising an input face which is inclined on the optical axis and the upper limit of which is formed by an edge not passing through the focal point of the ellipsoid-type reflector or through the focal point of the system consisting of the planar mirror and the dioptre of the output face.

According to a further possibility, the recovered beam is a variable beam, the recovery means comprising an input face inclined on the optical axis with a movable shield in front of the face.

### BRIEF DESCRIPTION OF THE DRAWINGS

The invention consists, apart from the provisions set out hereinbefore, of a certain number of further provisions which will be referred to hereinafter more explicitly with regard to embodiments which are described with reference to the enclosed drawings but do not entail any limitation. In these drawings:

FIG. 1 is a vertical schematic section passing through the optical axis of a headlamp according to the invention;

FIG. 2 is a schematic view in the direction of arrow 11 in FIG. 1;

FIG. 3 is a vertical schematic section on a larger scale of the recovery means according to the invention;

FIG. 4 is a horizontal projection of the transformation of a spherical wave surface into a planar wave surface by the recovery means of FIG. 3;

FIG. 5 is a schematic section through a horizontal plane of a variation of the recovery means from FIG. 3 for obtaining a widened beam;

FIG. 6 is a horizontal projection illustrating the beam having a cylindrical wave surface obtained with the recovery means from FIG. 5;

FIG. 7 is a schematic vertical section of a variation of the recovery means from FIG. 3;

FIG. 8 is a schematic illustration of the network of isolux curves obtained with the recovery means from FIG. 3;

FIG. 9 is a schematic illustration of a further network of isolux curves obtained with the recovery means from FIG. 5; and

FIG. 10 is a schematic plan view of a DBL headlamp according to the invention.

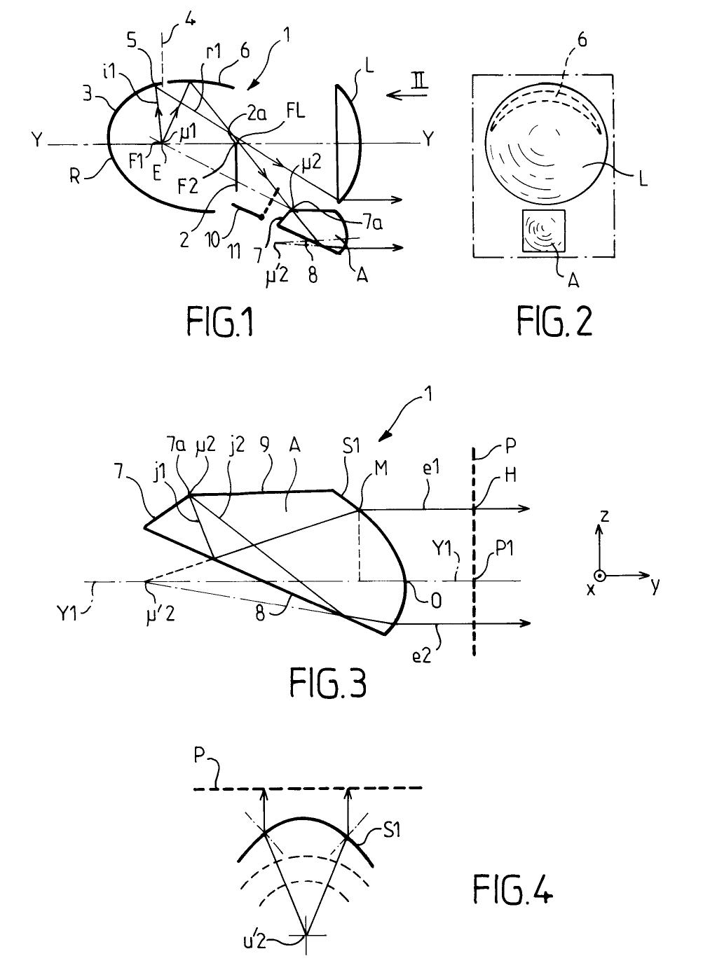

FIG. 1 of the drawings schematically illustrates a light headlamp module 1 comprising, along its optical axis Y-Y, an elliptical-type reflector R with at least one light source E placed in the vicinity of a first focal point F1, or the internal focal point of the reflector, of which the second focal point F2, or external focal point, is located further forward. The terms “front” and “back” are to be understood in view of the direction in which the light spreads which, according to FIG. 1, goes from left to right.

A converging lens L is placed in front of the reflector R and admits a focal point FL combined with the second focal point F2 or located in the vicinity of this second focal point of the reflector R.

A shield 2 is located between the reflector R and the lens L. In the example illustrated in FIG. 1, this shield 2 is formed by a screen orthogonal to the, normally horizontal, optical axis Y-Y. This shield 2, located in a vertical plane, is limited in its high portion by an upper edge 2a, forming a cut-off edge, located in the vicinity of the focal point FL of the lens L, or passing through this focal point.

In a variation, the vertical shield 2 could be replaced with a horizontal folder cutting off the beam.

A light recovery means A is provided in the low portion of the lens L to collect a portion of the flux, originating from the source E, directed downward and to send it forward.

The upper portion 3 of the reflector R beyond a zone 4 loses its effectiveness:

either the reflector R is calculated to lead the reflected rays to pass in proximity to the shield 2 and the focal point FL: in this case, the light rays issue from the lens;

or the reflector R is calculated to cause the rays to return into the lens; in this case, the light rays pass through the top of the shield 2 and are drawn markedly downward after passing through the lens. They then cause an excess of near-parasitic or worse-than-parasitic light when the rays issuing from the lens with a marked drawdown encounter aluminised-type parts of the headlamp.

In practice, the zone 4 is defined by a plane orthogonal to the axis Y-Y adjacent to a point such as 5 of the reflector. The point 5 is of the type sending a light ray i1, originating from the focal point F1, in the direction of a reflected ray r1 arriving on the lower edge of the lens L. The rays originating from the source E and falling onto the reflector R at points located in front of the point 5 will be reflected in the direction of the rays issuing from the lens L.

It will be noted that the source E is extended and that the reflector R is not necessarily focused at the center of the source. The “limit” rays pass at the lens edge and have to be drawn down by a sufficient angle (about 15 degrees) after issuing from the lens. This condition determines in a unique manner the passage of the limit ray in the plane of the shield at a point Δ.

As the lighting beams have a thickness of 10° to at most 15°, all rays in front of the zone 4:

either pass above the point Δ and then have a chance to return into the lens, but they are drawn down by an angle of greater than 15° and are therefore useless;

or pass below the point Δ, in which case they issue from the lens.

According to the invention, the upper portion 3 of the reflector R is cut in the vicinity of the zone 4 and is extended by an ellipsoid-type reflector 6, referred to in a simplified manner as the “elliptical mirror”, which admits a first focal point μ1 in the vicinity of the light source E and a second focal point μ2 located in front, lower than the optical axis Y-Y and than the focal point FL of the lens L. The second focal point μ2 can be located almost in the same vertical region as the lower edge of the lens L, although this is not necessary.

The mirror 6 focuses the light rays which it receives from the source E toward the focal point μ2 located between the lens L and the reflector R.

The light recovery means A is made of a transparent material, glass or plastics material such as polymethacrylate. It is disposed in the low portion of the lens and comprises an edge 7a, orthogonal to the plane of FIG. 1 which passes through the second focal point μ2 of the mirror 6.

The recovery means A is of one piece and has an input face 7 designed so that the light rays sent by the mirror 6 and falling onto this face 7 are deflected little or not at all on entering the recovery means A. This face 7 is basically planar and, for example, substantially orthogonal to the mean direction of the beam originating from the mirror 6. The input face 7 is inclined on the optical axis Y-Y and its upper limit forms the edge 7a passing through the focal point of the system consisting of the inclined plane 8 and the output face S1, which will be described in greater detail. This configuration is necessary to fulfil a function additional to the cut-off function. However, the invention encompasses the various cases in which the recovered beam is:

either a beam without a cut-off, in which case the edge 7a does not pass through the focal point μ2 or through the focal point of the system consisting of the mirror 8 and the dioptre S1;

or a variable beam, having a movable shield 10 in front of the face 7: the shield can be either in a position in which the entire face 7 is shielded and nothing is recovered; or in a position in which the edge of the shield passes through μ2, in which case a cut-off beam is recovered; or in a position in which a large portion of the face 7 is free beyond μ2, in which case a beam without a cut-off is obtained.

The low portion of the recovery means A is limited by a plane 8 inclined from the back toward the front. The inclination of this plane is provided to ensure total reflection of the rays which originated from the mirror 6 and entered the recovery means A. The rays are straightened by the recovery means A in order—on average—to be parallel to the optical axis of the output face of the recovery means.

This output face can assume a plurality of forms and be defined by a plurality of equations.

In a first case, it may be desirable for any light ray issuing from the focal point μ2 to emerge parallel to the optical axis Y1-Y1 of the recovery means A, parallel to the optical axis Y-Y. The output face S1 therefore has to be generated by revolution about the optical axis Y1-Y1. The rays reflected by the inclined plane 8 seem to originate from a point μ′2 (FIG. 3) which is the image of μ2 provided by the planar mirror 8. The output face S1 focuses all the rays issuing virtually from μ′2. Any ray issuing from μ2, and therefore virtually from μ′2, proceeds in the axis parallel to Y1-Y1. The output face S1 therefore transforms a spherical wave surface issuing from μ′2 into a planar wave surface P, orthogonal to the optical axis Y1-Y1, as illustrated in horizontal projection in FIG. 4.

FIG. 3 shows two light rays j1, j2 which issue from the focal point μ2 and, after being reflected onto the inclined plane 8 and refracted when crossing the output face S1, issue in the direction of the rays e1 and e2 parallel to Y1-Y1.

By considering a reference trirectangular trihedron in accordance with which the axis of the x's is perpendicular to the plane of FIG. 3, the axis of the y's is horizontal and the axis of the z's is vertical and by specifying the constancy of the optical path between the focal point μ2 and a planar wave surface P, orthogonal to Y1-Y1, the equations set out hereinafter are obtained, n being equal to the index of refraction of the material of the recovery means A.

For any point M on the surface S1:
n× μ̅′̅₂̅M̅+ M̅H̅= O̅P̅₁+n× μ̅′̅₂̅O̅

wherein P1 is the intersection of the optical axis Y1-Y1 and the planar wave surface P and H is the intersection of the ray issuing through M with the surface P.

On the one hand, by selecting P1 so as to be combined with O, the peak of the surface S1, and by specifying that μ′₂O=f and, on the other hand, by taking the origin of the marker at O, the following is obtained:
n×{square root over (((yM−f)²+zM²+xM²)}+yM=n×f
(xM, yM and zM being the coordinates following Ox, Oy and Oz of the point M).

This is the equation of an ellipsoid, one of the focal points of which is none other than μ′2 (FIG. 4).

If the elliptical mirror 6 (FIG. 1) extending the reflector R is a perfect ellipsoid, the lighting at the input of the recovery means A is highly focused, in particular along the edge 7a perpendicular to the plane of FIGS. 1 and 3. The output surface S1 focuses all the rays, leading at the output to a cluster of parallel rays e1, e2 that is highly concentrated in width. Such a concentration in width may not be desirable.

To widen the beam issuing from the face S1, it is conceivable to widen the spot at the input 7a of the recovery means A. However, a solution of this type is not desirable as, on the one hand, the recovery means becomes larger and, on the other hand, the light losses greater owing to the curvature of the output face S1.

The invention proposes an advantageous solution consisting in designing an output face S2 (FIG. 5) which allows the vertical deflection properties of the surface S1 from FIGS. 1 and 3 to be maintained while widening the beam in the horizontal planes.

The surface S2 is determined in such a way that the wave surface Pₐ is no longer planar, as in the case of FIGS. 3 and 4, but rather cylindrical with vertical generatrices.

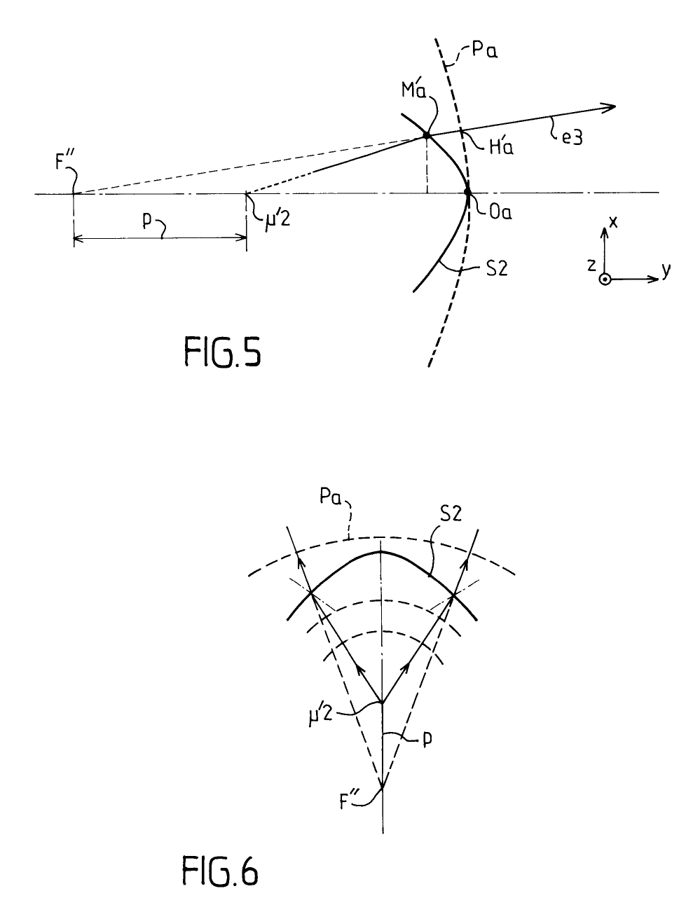

The paths of the light rays in a vertical plane are identical to the illustration of FIG. 3. In a horizontal plane, on the other hand, corresponding to the plan view of FIG. 5, the tracing of the wave surface Pₐ on the horizontal plane can be considered as a circle, the centre of which is located at a point F″. The distance p=μ′₂F″ then determines the width of the spot, i.e. the opening angle of the beam in the horizontal plane. The light rays issuing from the face S2 have projections on a horizontal plane such as e3 (FIG. 5) that are orthogonal to the wave surface Pₐ and therefore correspond to radii of the circle passing through the centre F″. FIG. 6 illustrates in horizontal projection the wave surface Pₐ.

If p has a low value, the radius of the circle Pₐ is also low and the end rays e3 are markedly divergent, so the spot or opening angle of the beam is large. If, on the other hand, p is large, the spot contracts. When p tends toward infinity, the output surface S2 is reduced to the surface S1 of FIG. 3.

As for the surface S1 of FIG. 3, the equation of the surface S2 is written by expressing the preservation of the optical path: for any point Ma pertaining to the output surface S2:
n× μ̅′̅₂̅M̅ₐ̅+ M̅ₐ̅H̅ₐ̅=n× μ̅′̅₂̅Oₐ=n×f (1)
n is the index of refraction of the material of the recovery means, Ha is the intersection of the ray issuing through Ma with the surface Pa and Oa is the peak of S2. As Ha is located on the cylinder of center F″ and of radius R, the projections on the horizontal plane of F″, of Ma and of Ha pertain to a single straight line. By designating as M′a and H′a the projections of Ma and Ha on the horizontal plane, there is obtained, taking F″ as the origin:

for any point Ma pertaining to the surface S2:
M̅ₐ̅′̅H̅ₐ̅′̅= F̅″̅H̅ₐ̅′̅− F̅″̅M̅ₐ̅′̅=R−\sqrt{(yMₐ−p)²+xMₐ²} (2)
M̅ₐ̅H̅ₐ̅ can be replaced by M′aH′a then, at the output of S2, the radius is calculated to be found in a horizontal plane parallel to the plane Oxy, the condition for forming the horizontal cut-off. Accordingly, the projections M̅ₐ̅′̅H̅ₐ̅′̅ onto Oxy are indeed equal to M̅ₐ̅H̅ₐ̅ By incorporating Equation (2) into Equation (1), the following is obtained:

for any point Ma pertaining to the surface S2:
n× μ̅′̅₂̅M̅ₐ̅+R−{square root over (((yMₐ−p)²+xMₐ²)}=n×f
i.e n×{square root over (((yMₐ²+xMₐ²+zMₐ²))}+R−{square root over (((yMₐ−p)²+zMₐ²)}=n×f (3)
This is a quadric which is solved by setting polar coordinate parameters.

The last element of the recovery means A is the high portion 9 joining the input face 7 to the output face S1, S2. It will be noted that this high portion is joined to the input face 7 in the region of the focal point located on the edge 7a. This allows a cut-off to be formed in the light beam in two different manners.

According to a first manner, the high portion 9 is coated with a black paint so as to prevent the light rays from entering through this high portion 9. Only the rays passing below the edge 7a and below μ₂ issue through S1 or through S2, hence the formation of a cut-off.

According to a second manner, it is advantageous to overmold the transparent recovery means A with an opaque material on the high portion 9. An overmolding process of this type is conventional and allows the blocking-out part to be positioned with a high degree of precision relative to the recovery means A. Furthermore, the blocking-out part can also have a mechanical function allowing the recovery means A to be positioned and fixed relative to the light module.

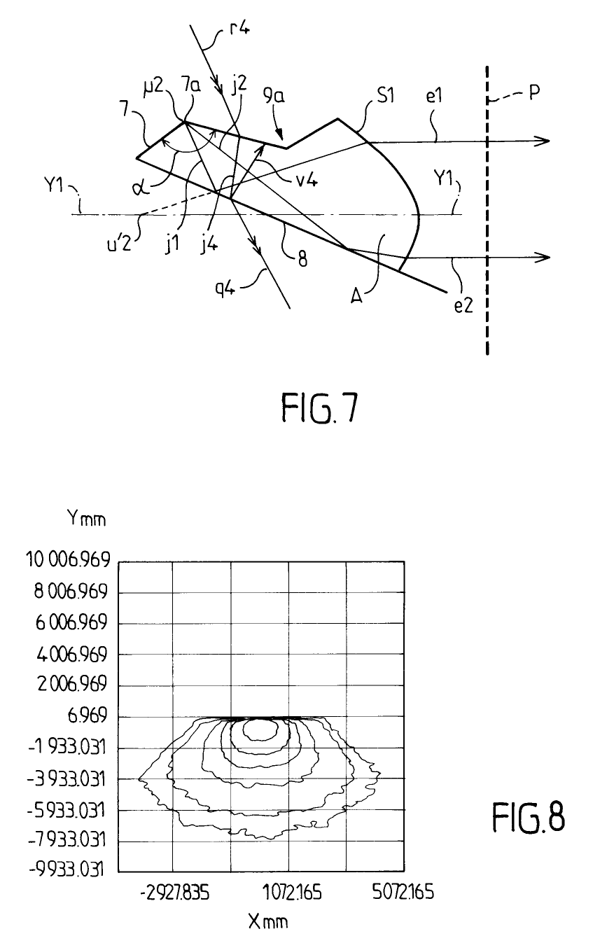

According to a further possibility, there is defined a high portion 9a (FIG. 7) allowing a shield to be dispensed with while at the same time providing the desired cut-off.

Specifically, the high portion 9a forms, with the input face 7 of the recovery means, an angle α sufficiently large to allow rays such as r4 arriving on the upper face 9a to be markedly deflected in the direction of rays such as j4. The rays j4 arrive on the lower face 8 no longer with an incidence ensuring total reflection but rather at an incidence close to the normal. The major portion issues in the direction of rays such as q4 which are lost and do not return to the forward-projected beam. As a small fraction of a ray j4 can be reflected at v4, it may prove necessary to place a shield, to prevent any parasitic influence, on the high portion 9a toward the front, but not necessarily on the edge of the input face 7.

FIG. 8 illustrates the network of isolux curves obtained on a screen placed at 25 m from the headlamp in the case in which the recovery means A has an output surface S1 (FIG. 3). The cluster of isolux curves is fairly concentrated in terms of width, in practice a width of ±2 m at 25 m, i.e. an opening angle of ±4.5 degrees (arc tangent 2/25=4.5 degrees). The beam, on the other hand, is very thick (vertical dimension). Its thickness can be limited by limiting merely the size of the input face.

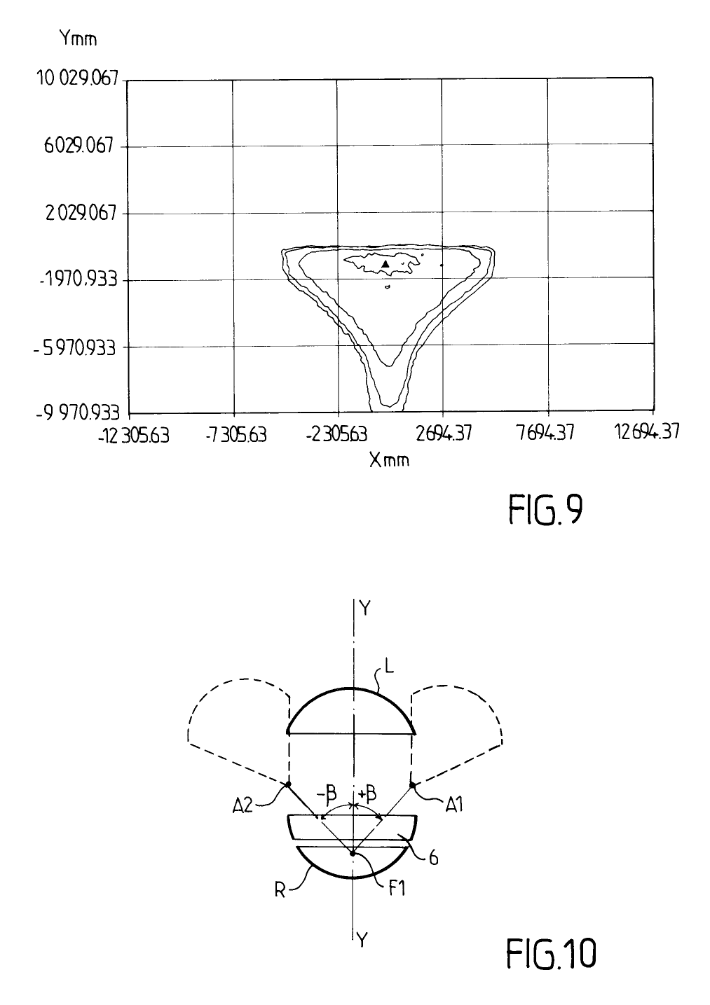

In the case of a recovery means A with the output surface S2 (FIG. 5), a wider isolux network can be obtained (FIG. 9) without a loss of flux with a width of approximately ±5 m at 25 m, i.e. an opening angle of ±11 degrees (arc tangent 5/25=11 degrees). It is possible to go beyond this.

Apart from the formation of the cut-off, the recovery of light obtained owing to the invention provides good flexibility to change the features of the beam. This can be attained as disclosed hereinafter.

According to a first possibility, a movable shield 10 (FIG. 1), for example a shield mounted so as to be able to rotate about axis 11 perpendicular to the plane of FIG. 1, is provided in the region of the input face 7 of the recovery means. The shield 10 can be in a withdrawn position indicated by solid lines in FIG. 1, in which it allows the light to pass toward the input face 7, or conversely occupy the position indicated by broken lines, in which it blocks out this light.

According to a second possibility, the entire module or headlamp is caused to move, for example by rotation about a vertical axis. This is what happens when the module is mounted on a DBL (“dynamic bending light”) rotating plate. The recovery means A can then be positioned and designed in such a way that in the rest position of the module, i.e. with the optical axis Y-Y parallel to the longitudinal axis of the vehicle, the light originating from the additional elliptical mirror passes beside the recovery means. In the operating position, on the other hand, when the module on its DBL plate has rotated relative to the longitudinal axis of the vehicle, the module is then positioned facing the recovery means A which then becomes active.

FIG. 10 illustrates schematically an arrangement of this type. Two recovery means A1, A2 are fixed either side of the optical axis Y-Y of a module or headlamp movable in rotation about a vertical axis. The straight line joining the first focal point F1 of the reflector R and the environment of the edge of each recovery means A1, A2 forms an angle ±β with the optical axis Y-Y when said optical axis is parallel to the longitudinal axis of the vehicle.

In the position illustrated in FIG. 10, the optical axis Y-Y of the module is parallel to the longitudinal axis of the vehicle and the light issuing from the elliptical mirror 6 extending the reflector R passes beside each of the recovery means A1, A2 which are therefore inactive.

When the driver turns his wheels, to the right for example in order to negotiate a bend, the module turns and the light issuing from the module will reach the recovery means A1 completely once the optical axis Y-Y has turned through an angle β. The light recovered by the recovery means A1 then allows the lighting to be improved within the bend. The recovery means A2 would intervene for a left bend.

The recovery means A, A1 or A2 according to the invention consists of a small part which can easily be made of glass or of plastics material. Furthermore, the production and the formation of the cut-off of the beam is not dependent on the position of the recovery means relative to the module, hence there is highly flexible tolerance on the position of the recovery means.

The additional light flux is obtained without adding an additional light source.

The invention provides an original style. The increase in the range of the light beam may be very much greater than that obtained with shield movements in known headlamps.

The flexibility of the solution of the invention provides varied forms of isolux network. A movable shield such as 10 utilises merely a very simple mechanical system.

The invention can also supplement rotating shield systems. In other words, the invention is fully compatible with systems used for bifunctional dipped and full-beam headlamps (bi-halogens or bi-xenons for example). This allows much higher performance level values. The light source can have a transverse or axial configuration relative to the optical axis of the module.

The examples given for the output surfaces S1, S2 do not entail any limitation.

The invention provides a clear cut-off of the beam, without achromatism, with a one-piece recovery means which itself manages the cut-off. The solution of the invention allows the range of a headlamp on a motorway to be increased, in particular, by adding a band of fine light very far away from the vehicle and by eliminating/reducing any excessive near light.

The gain in light flux provided by the invention is significant. For example, with a xenon lamp-type source, for a dipped beam having a light flux of 1,000 lumens, approximately 100 lumens are added in accordance with the invention. With regard to lighting, this results in a gain of approximately 30 lux at 25 m, passing from approximately 50 to 80 lux.

There are a relatively large number of applications.

For a motorway headlamp, the output face of the recovery means tends to be elliptical and the input face is relatively narrow. A shield 10 is generally provided which is withdrawn for motorway driving.

The FBL (“fixed bending light”) application also employs a shield which is withdrawn when a surplus of lighting is desired.

According to a further possibility, the recovery means is combined with a DBL (“dynamic bending light”) and the elliptical module is able to rotate whereas the recovery means is fixed.

The invention is also suitable for applications such as:

bi-halogen (dipped and full-beam) headlamp with the recovery means portion forming a wide and thick beam;

transverse filament headlamp, which has the advantage of being highly effective, the amount of flux recovered being very considerable.

While the form of apparatus herein described constitute a preferred embodiment of this invention, it is to be understood that the invention is not limited to this precise form of apparatus, and that changes may be made therein without departing from the scope of the invention which is defined in the appended claims.

What is claimed is:

1. A headlamp optical module for a motor vehicle comprising, disposed along an optical axis:
an elliptical-type reflector with at least one light source placed in a vicinity of a first focal point of the elliptical-type reflector;
a converging lens placed in front of said elliptical-type reflector and admitting a focal point located in a vicinity of a second focal point of the elliptical-type reflector, or combined therewith;
and, in its low portion, a light recovery means suitable for collecting a portion of the flux from said light source and for sending it forward, said headlight optical module comprising:
an ellipsoid-type reflector provided at a front, in an upper portion of said headlamp optical module, said ellipsoid-type reflector focusing a portion of rays issuing from said at least one light source in said vicinity of said second focal point located at said front, lower than a focal point of said converging lens,
and said light recovery means comprising an input face, in proximity to which is located said second focal point of said ellipsoid-type reflector.

2. The optical module according to claim 1, wherein the upper front portion of said elliptical-type reflector located above the optical axis is stopped in the region of a zone corresponding to the end rays which, after reflection onto said elliptical-type reflector, are collected as limit rays by said converging lens.

3. The optical module according to claim 1, wherein said light recovery means is made of a one-piece transparent material.

4. The optical module according to claim 1, wherein said light recovery means comprises an input face inclined on the optical axis of the headlamp, having an upper limit.

5. The optical module according to claim 3, wherein said input face of said light recovery means is disposed so that the rays reflected by the ellipsoid-type reflector and falling onto said input face are hardly or minimally deflected.

6. The optical module according to claim 1, wherein said input face of said light recovery means is substantially planar.

7. The optical module according to claim 1, wherein said light recovery means is limited in its low portion by an inclined surface operating in total reflection, the rays being straightened by said light recovery means such that on average, they become substantially parallel to the optical axis of an output face of said light recovery means.

8. The optical module according to claim 1, wherein an output face of said light recovery means is generated by revolution about said optical axis.

9. The optical module according to claim 7, taken in conjunction with each other, wherein said output face admits as the meridian vertical section an elliptic arc, one focal point of which is the image provided by the inclined plane of the second focal point (μ₂) of the ellipsoid-type reflector, in order to form an emerging beam admitting a planar wave surface, substantially orthogonal to the optical axis.

10. The optical module according to claim 1, wherein said output face admits as the horizontal section that of a given quadric to provide at the output a cylindrical wave plane having substantially vertical generatrices.

11. The optical module according to claim 1, which comprises a movable shield in the region of said input face of the recovery means, said movable shield being able to be placed in a withdrawn position, in which it allows the light to pass toward the input face, or to occupy a position in which it blocks out this light.

12. The optical module according to claim 1, wherein the headlamp optical module is mounted so as to be movable and said light recovery means is fixed and placed in such a way that in the rest position of the headlamp the light originating from said additional ellipsoid-type reflector passes beside said light recovery means, whereas in the operating position the headlamp is positioned facing said light recovery means which then becomes active.

13. The optical module according claim 1, which comprises a shield located between said ellipsoid-type reflector and said lens, limited by an end edge, forming a cut-off edge, located in the vicinity of the focal point of said lens.

14. The optical module according to claim 7, wherein said light recovery means comprises an input face which is inclined on the optical axis and the upper limit of which is formed by an edge passing through the focal point of the system formed by the planar mirror and the dioptre of the output face.

15. The optical module according to claim 7, wherein a recovered beam is a beam without a cut-off, said light recovery means comprising an input face which is inclined on the optical axis and the upper limit of which is formed by an edge not passing through the focal point of the ellipsoid-type reflector) or through the focal point of the system consisting of the planar mirror and the dioptre of the output face.

16. The optical module according to claim 7, wherein a recovered beam is a variable beam, said light recovery means comprising an input face inclined on the optical axis with a movable shield in front of the face.

17. An ellipsoid-type reflector for use in a headlamp optical module, said ellipsoid-type reflector comprising:
a lens for focusing a portion of rays issuing from at least one light source in said headlamp optical module toward an ellipsoid focal point that is lower than a focal point of the converging lens and an optical axis of said headlamp optical module.

18. The optical module according to claim 17, wherein said light recovery device is made of a one-piece transparent material.

19. The optical module according to claim 17, wherein said light recovery means comprises an input face inclined on the optical axis of the headlamp, having an upper limit.

20. The optical module according to claim 18, wherein said input face of said light recovery device is disposed so that the rays reflected by the ellipsoid-type reflector and falling onto said input face are hardly deflected minimally.

21. The optical module according to claim 17, wherein said input face of said light recovery device is substantially planar.
